(19) United States
(12) Patent Application Publication
(10) Pub. No.: US 2013/0155339 A1
(43) Pub. Date: Jun. 20, 2013

(54) LIQUID CRYSTAL DISPLAY DEVICE AND METHOD FOR MANUFACTURING THE SAME

(71) Applicant: Japan Display East Inc., Mobara-shi (JP)

(72) Inventors: Mika OIWA, Chiba (JP); Shintaro TAKEDA, Mito (JP); Shinichi KOMURA, Chiba (JP)

(73) Assignee: JAPAN DISPLAY EAST INC., Mobara-shi (JP)

(21) Appl. No.: 13/719,271

(22) Filed: Dec. 19, 2012

(30) Foreign Application Priority Data
Dec. 19, 2011 (JP) 2011-276880

(51) Int. Cl. G02F 1/133

(52) U.S. Cl. CPC G02F 1/13306
USPC 349/33; 156/275.5

(57) ABSTRACT

Provided is a liquid crystal display device, including: a first substrate; a second substrate; a liquid crystal material interposed between the first substrate and the second substrate, and combined with a polymer composition to exhibit a blue phase; and a pair of transparent electrodes formed on the first substrate, for applying a lateral field to the liquid crystal material, the lateral field being parallel to the first substrate. The polymer composition is formed to have different densities in a direction between the first substrate and the second substrate. At least in a region overlapping with the pair of transparent electrodes, the polymer composition has a part having a highest density, the part being located closer to the first substrate than to the second substrate.

### CROSS-REFERENCE TO RELATED APPLICATION

The present application claims priority from Japanese Patent Application JP2011-276880 filed on Dec. 19, 2011, the content of which is hereby incorporated by reference into this application.

### BACKGROUND OF THE INVENTION

1. Field of the Invention

The present invention relates to a liquid crystal display device and a method of manufacturing the same.

2. Description of the Related Art

Blue phase liquid crystal is disclosed in Japanese Patent Application Laid-open No. 2010-250306 and the like as a liquid crystal material used in a liquid crystal panel. The blue phase liquid crystal realizes a faster response as compared to nematic liquid crystal, and is optically isotropic. Therefore, the blue phase liquid crystal has no viewing angle dependence. As a result, the liquid crystal panel does not require any of an alignment film, alignment processing such as rubbing, and an optical film for viewing angle compensation. Therefore, a thin and inexpensive liquid crystal panel can be formed. Further, a temperature range in which the blue phase can exist in a stable state has been extremely narrow, but owing to appearance of a technology that expands this range, the practical use of the blue phase is now expected.

Japanese Patent Application Laid-open No. 2010-250306 discloses the idea of, in order to provide a highly reliable blue phase liquid crystal display device, scanning light irradiation means to selectively perform polymer stabilization treatment, thereby separately forming regions having a low polymerization degree and a high polymerization degree. Note that, Japanese Patent Application Laid-open No. 2010-250306 discloses the idea of reducing the polymerization degree in a region brought into contact with the sealant.

The inventors of the present invention have studied the blue phase liquid crystal, and have found that display characteristics differ depending on the polymer structure formed in the blue phase liquid crystal. In view of this, the inventors of the present invention have found a method of preventing, when the blue phase liquid crystal is used in a lateral-field type liquid crystal panel, a phenomenon called “screen burn-in” in which arrangement of liquid crystal molecules is fixed due to continuous display of the same image for a long period of time.

### SUMMARY OF THE INVENTION

It is an object of the present invention to prevent a screen burn-in phenomenon when blue phase liquid crystal is used in a lateral-field type liquid crystal panel.

(1) According to an exemplary embodiment of the present invention, there is provided a liquid crystal display device, including: a first substrate; a second substrate; a liquid crystal material interposed between the first substrate and the second substrate, and combined with a polymer composition to exhibit a blue phase; and a pair of transparent electrodes formed on the first substrate, for applying a lateral field to the liquid crystal material, the lateral field being parallel to the first substrate. The polymer composition is formed to have different densities in a direction between the first substrate and the second substrate. At least in a region overlapping with the pair of transparent electrodes, the polymer composition has a part having a highest density, the part being located closer to the first substrate than to the second substrate. According to the exemplary embodiment of the present invention, the polymer composition density is higher on the first substrate side on which the field intensity becomes large, and hence it is possible to stably maintain the liquid crystal molecules, and prevent the screen burn-in phenomenon.

(2) In the liquid crystal display device according to Item (1), at least in the region overlapping with the pair of transparent electrodes, the polymer composition may have a part close to the first substrate, the part having a density that is higher than a density at another part of the polymer composition, which is close to the second substrate.

(3) The liquid crystal display device according to Item (1) or (2) may further include a metal electrode formed on the first substrate. The polymer composition may be formed so as to avoid a region overlapping with the metal electrode. In the region overlapping with the metal electrode, a photocurable resin may be added to the liquid crystal material.

(4) The liquid crystal display device according to Item (1) or (2) may further include: a metal electrode formed on the first substrate; and a light reflective film formed on the second substrate so as to be opposed to the metal electrode. In a region overlapping with the metal electrode, the polymer composition may have a part close to the second substrate, the part having a density higher than a density at another part of the polymer composition, which is close to the first substrate.

(5) The liquid crystal display device according to Item (1) or (2) may further include: a metal electrode formed on the first substrate; and a light reflective film formed on the second substrate so as to be opposed to the metal electrode. In a region overlapping with the metal electrode, the liquid crystal material may have a part close to the first substrate, the part being added with a photocurable resin, and another part close to the second second substrate, the another part being combined with the polymer composition.

(6) In the liquid crystal display device according to Item (4) or (5), the light reflective film may reflect ultraviolet light and transmit visible light.

(7) According to an exemplary embodiment of the present invention, there is provided a method of manufacturing a liquid crystal display device, including: interposing a liquid crystal material added with a photocurable resin between a first substrate and a second substrate; and applying light to the photocurable resin via the first substrate, the first substrate having a pair of transparent electrodes formed thereon, for applying a lateral field to the liquid crystal material, the lateral field being parallel to the first substrate. The applying light includes generating a polymer composition from the photocurable resin through energy absorption from the light, the light traveling while reducing the energy in a direction from the first substrate to the second substrate, thereby generating, in the polymer composition at least in a region overlapping with the pair of transparent electrodes, a part having a highest density, which is located closer to the first substrate than to the second substrate. According to the exemplary embodiment of the present invention, the polymer composition density is higher on the first substrate side on which the field intensity becomes large, and hence it is possible to stably maintain the liquid crystal molecules, and prevent the screen burn-in phenomenon.

(8) In the method of manufacturing a liquid crystal display device according to Item (7), at least in the region overlapping with the pair of transparent electrodes, the polymer composition may have a part close to the first substrate, the part having a density that is higher than a density at another part of the polymer composition, which is close to the second substrate.

(9) In the method of manufacturing a liquid crystal display device according to Item (7) or (8), the first substrate may have a metal electrode formed thereon, and the applying light may include generating the polymer composition so as to avoid a region overlapping with the metal electrode that blocks the light.

(10) In the method of manufacturing a liquid crystal display device according to Item (7) or (8), the first substrate may have a metal electrode formed thereon, the metal electrode blocking the light, the second substrate may have alight reflective film formed thereon, the light reflective film being opposed to the metal electrode, and the applying light may include reflecting the light by the light reflective film so that the light enters a region overlapping with the metal electrode.

(11) In the method of manufacturing a liquid crystal display device according to Item (10), the light may be ultraviolet light, and the light reflective film may reflect the ultraviolet light and transmit visible light.

### BRIEF DESCRIPTION OF THE DRAWINGS

In the accompanying drawings:

FIG. 1 is a sectional view illustrating a liquid crystal display device according to a first embodiment of the present invention;

FIG. 2 is a sectional view illustrating a method of manufacturing the liquid crystal display device according to the first embodiment of the present invention;

FIG. 3 is a sectional view illustrating a liquid crystal display device according to a second embodiment of the present invention;

FIG. 4 is a sectional view illustrating a method of manufacturing the liquid crystal display device according to the second embodiment of the present invention; and

FIG. 5 is a sectional view illustrating a liquid crystal display device according to a modified example of the second embodiment of the present invention.

### DETAILED DESCRIPTION OF THE INVENTION

In the following, embodiments of the present invention are described with reference to the drawings.

### First Embodiment

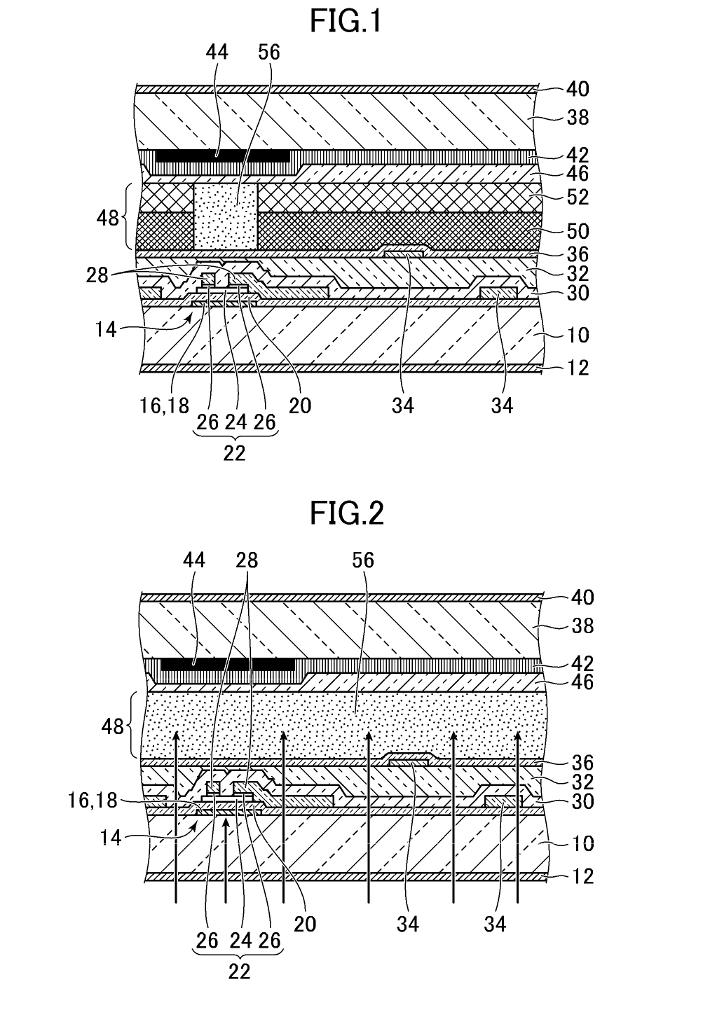

FIG. 1 is a sectional view illustrating a liquid crystal display device according to a first embodiment of the present invention. The liquid crystal display device includes a first substrate 10. The first substrate 10 has a light transmissive property, and is made of glass, a resin, or the like. On one surface (lower surface in FIG. 1) of the first substrate 10, a first polarizing plate 12 is bonded. The first polarizing plate 12 passes light that is polarized in a specific direction. The first substrate 10 is also called a thin film transistor (TFT) substrate because a thin film transistor 14 is formed thereon.

Specifically, a gate electrode 16 is formed on the first substrate 10. The gate electrode 16 is made of a metal such as aluminum. In other words, a metal electrode 18 is formed on the first substrate 10. The metal electrode 18 blocks light. A gate insulating film 20 is formed so as to cover the gate electrode 16 (metal electrode 18). The gate insulating film 20 is made of an inorganic material such as SiN, and has a light transmissive property. Above the gate electrode 16 and on the gate insulating film 20, a semiconductor thin film 22 (for example, amorphous silicon thin film) is formed. The semiconductor thin film 22 includes a lower layer 24, and an upper layer 26 in which a larger amount of impurities are doped as compared to the lower layer 24. A pair of upper layers 26 is formed on the lower layer 24 at an interval.

A pair of wirings 28 is formed on the gate insulating film 20 and the semiconductor thin film 22. The pair of wirings 28 has a light transmissive property, and made of a transparent conductive material such as indium tin oxide (ITO). The pair of wirings 28 is arranged so as to avoid the lower layer 24 of the semiconductor thin film 22, and is formed on the pair of upper layers 26. Parts of the pair of wirings 28 formed on the pair of upper layers 26 are a drain electrode and a source electrode of the thin film transistor 14, respectively. The thin film transistor 14 is covered with one or a plurality of layers of insulating films 30 and 32. The insulating films 30 and 32 are also made of an inorganic material such as SiN, and have a light transmissive property.

A pair of transparent electrodes 34 is formed on the first substrate 10. The pair of transparent electrodes 34 is arranged through intermediation of the insulating films 30 and 32. When a voltage is applied to both the transparent electrodes 34, a lateral field parallel to the first substrate 10 is generated. One of the pair of transparent electrodes 34 is a part of one of the pair of wirings 28, and is electrically connected to one of the drain electrode and the source electrode. In this manner, the voltage is controlled for each pixel. On the other hand, the other transparent electrode 34 is a common electrode, and a common voltage is applied to a plurality of pixels. The other transparent electrode 34 formed on the insulating films 30 and 32 is covered with a passivation film 36. The passivation film 36 also has a light transmissive property.

The liquid crystal display device includes a second substrate 38. The second substrate 38 has alight transmissive property, and is made of glass, a resin, or the like. On one surface (upper surface in FIG. 1) of the second substrate 38, a second polarizing plate 40 is bonded. The second polarizing plate 40 passes light that is polarized in a direction orthogonal to the direction in which the light passing through the first polarizing plate 12 is polarized. The second substrate 38 is also called a color filter (CF) substrate because a color filter (not shown) is formed thereon.

Specifically, on the second substrate 38, a colored layer 42 is formed on a surface on a side opposite to the second polarizing plate 40. Further, a black matrix 44 is formed on the second substrate 38, and the black matrix 44 is covered with the colored layer 42. The colored layer 42 is covered with a planarizing layer 46.

The liquid crystal display device includes a liquid crystal material 48. The liquid crystal material 48 is interposed between the first substrate 10 and the second substrate 38. The liquid crystal material 48 is combined with a polymer composition to exhibit a blue phase. A lateral field is applied to the liquid crystal material 48 when a voltage is applied to the pair of transparent electrodes 34. The driving system for the liquid crystal display device according to this embodiment is, for example, an in-plane switching system.

The polymer composition is formed to have different densities in a direction between the first substrate 10 and the second substrate 38. At least in a region overlapping with the pair of transparent electrodes 34, the polymer composition has a part 50 having the highest density, which is located closer to the first substrate 10 than to the second substrate 38. In other words, the part 50 of the polymer composition, which is close to the first substrate 10, has a density that is higher than that at a part 52 of the polymer composition, which is close to the second substrate 38. The polymer composition is formed so as to avoid a region overlapping with the metal electrode 18. In the region overlapping with the metal electrode 18, a photocurable resin 56 is added in the liquid crystal material 48.

According to this embodiment, the pair of transparent electrodes 34 for generating a parallel lateral field is formed on the first substrate 10, and hence the field intensity becomes large on the first substrate 10 side, but the polymer composition density is higher on the first substrate 10 side. Therefore, it is possible to stably maintain liquid crystal molecules, and prevent a screen burn-in phenomenon.

FIG. 2 is a sectional view illustrating a method of manufacturing the liquid crystal display device according to the first embodiment of the present invention. In this embodiment, the liquid crystal material 48 added with the photocurable resin 56 is interposed between the first substrate 10 and the second substrate 38. An ultraviolet curable resin is used as the photocurable resin 56. Then, light is applied to the photocurable resin 56 via the first substrate 10. Ultraviolet light is used as the light. Through energy absorption from the light, the polymer composition is generated from the photocurable resin 56. The light travels while reducing its energy in the direction from the first substrate 10 to the second substrate 38. Therefore, the part 50 (see FIG. 1) of the polymer composition, which has the highest density, is generated closer to the first substrate 10 than to the second substrate 38. In other words, the part 50 of the polymer composition, which is close to the first substrate 10, can have a density that is higher than that of the part 52 (see FIG. 1) of the polymer composition, which is close to the second substrate 38.

According to this embodiment, the polymer composition density is higher on the first substrate 10 side on which the field intensity becomes large, and hence it is possible to stably maintain the liquid crystal molecules, and prevent the screen burn-in phenomenon. Note that, light is blocked by the metal electrode 18, and hence the light does not travel in the region overlapping with the metal electrode 18. Therefore, the polymer composition is generated so as to avoid the region overlapping with the metal electrode 18.

### Second Embodiment

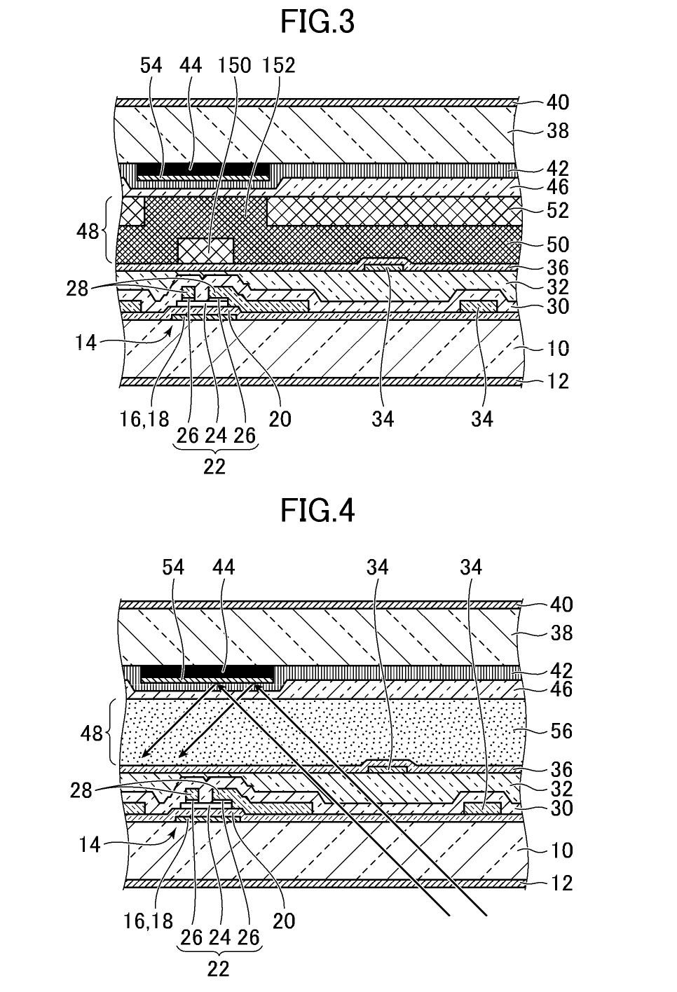

FIG. 3 is a sectional view illustrating a liquid crystal display device according to a second embodiment of the present invention. In this embodiment, a light reflective film 54 is formed on the second substrate 38 so as to be opposed to the metal electrode 18. For example, the light reflective film 54 is formed on a surface of the black matrix 44 directed to the liquid crystal material 48. The light reflective film 54 reflects ultraviolet light, and transmits visible light. The light reflective film 54 may be made of, but not limited to, aluminum oxide or germanium oxide, or may be formed of a low-density polyolefin-based synthetic resin film containing glycerin or a film obtained by coating a metal such as titanium oxide, zinc oxide, or cerium oxide with silicon or fluorine. Other configurations correspond to the contents described in the first embodiment.

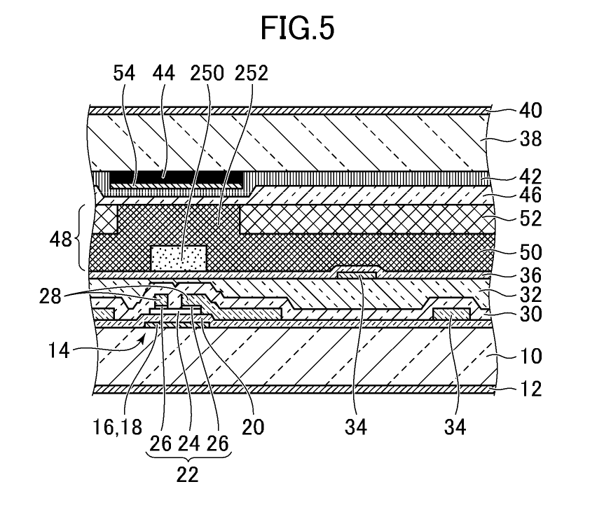

FIG. 4 is a sectional view illustrating a method of manufacturing the liquid crystal display device according to the second embodiment of the present invention. In this embodiment, in a step of applying light, the light is reflected by the light reflective film 54 so that the light enters the region overlapping with the metal electrode 18. Ultraviolet light is used as the light.

In this manner, as illustrated in FIG. 3, the polymer composition can be formed also in the region overlapping with the metal electrode 18. Note that, in the region overlapping with the metal electrode 18, a part 152 of the polymer composition, which is close to the second substrate 38, has a density higher than that of a part 150 of the polymer composition, which is close to the first substrate 10.

FIG. 5 is a sectional view illustrating a liquid crystal display device according to a modified example of the second embodiment of the present invention. In this example, in the region overlapping with the metal electrode 18, a part 250 of the liquid crystal material 48, which is close to the first substrate 10, is in a state in which a photocurable resin is added thereto. In other words, the polymer composition is not formed in this part 250. However, in the region overlapping with the metal electrode 18, a part 252 of the liquid crystal material 48, which is close to the second substrate 38, is combined with the polymer composition. Such a configuration may be obtained depending on how the light travels.

The present invention is not limited to the embodiments described above, and various modifications may be made thereto. For example, the structures described in the embodiments may be replaced by a structure having substantially the same structure, a structure having the same action and effect, and a structure which may achieve the same object.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a first substrate;
a second substrate;
a liquid crystal material interposed between the first substrate and the second substrate, and combined with a polymer composition to exhibit a blue phase; and
a pair of transparent electrodes formed on the first substrate, for applying a lateral field to the liquid crystal material, the lateral field being parallel to the first substrate,
wherein the polymer composition is formed to have different densities in a direction between the first substrate and the second substrate, and
wherein, at least in a region overlapping with the pair of transparent electrodes, the polymer composition has a part having a highest density, the part being located closer to the first substrate than to the second substrate.

2. The liquid crystal display device according to claim 1, wherein, at least in the region overlapping with the pair of transparent electrodes, the polymer composition has a part close to the first substrate, the part having a density that is higher than a density at another part of the polymer composition, which is close to the second substrate.

3. The liquid crystal display device according to claim 1, further comprising a metal electrode formed on the first substrate,
wherein the polymer composition is formed so as to avoid a region overlapping with the metal electrode, and
wherein, in the region overlapping with the metal electrode, a photocurable resin is added to the liquid crystal material.

4. The liquid crystal display device according to claim 1, further comprising:
a metal electrode formed on the first substrate; and
a light reflective film formed on the second substrate so as to be opposed to the metal electrode,
wherein, in a region overlapping with the metal electrode, the polymer composition has a part close to the second substrate, the part having a density higher than a density at another part of the polymer composition, which is close to the first substrate.

5. The liquid crystal display device according to claim 1, further comprising:
a metal electrode formed on the first substrate; and
a light reflective film formed on the second substrate so as to be opposed to the metal electrode,
wherein, in a region overlapping with the metal electrode, the liquid crystal material has apart close to the first substrate, the part being added with a photocurable resin, and another part close to the second second substrate, the another part being combined with the polymer composition.

6. The liquid crystal display device according to claim 4, wherein the light reflective film reflects ultraviolet light and transmits visible light.

7. The liquid crystal display device according to claim 5, wherein the light reflective film reflects ultraviolet light and transmits visible light.

8. A method of manufacturing a liquid crystal display device, comprising:
interposing a liquid crystal material added with a photocurable resin between a first substrate and a second substrate; and
applying light to the photocurable resin via the first substrate,
the first substrate having a pair of transparent electrodes formed thereon, for applying a lateral field to the liquid crystal material, the lateral field being parallel to the first substrate,
wherein the applying light comprises generating a polymer composition from the photocurable resin through energy absorption from the light, the light traveling while reducing the energy in a direction from the first substrate to the second substrate, thereby generating, in the polymer composition at least in a region overlapping with the pair of transparent electrodes, a part having a highest density, which is located closer to the first substrate than to the second substrate.

9. The method of manufacturing a liquid crystal display device according to claim 8, wherein, at least in the region overlapping with the pair of transparent electrodes, the polymer composition has a part close to the first substrate, the part having a density that is higher than a density at another part of the polymer composition, which is close to the second substrate.

10. The method of manufacturing a liquid crystal display device according to claim 8,
wherein the first substrate has a metal electrode formed thereon, and
wherein the applying light comprises generating the polymer composition so as to avoid a region overlapping with the metal electrode that blocks the light.

11. The method of manufacturing a liquid crystal display device according to claim 8,
wherein the first substrate has a metal electrode formed thereon, the metal electrode blocking the light,
wherein the second substrate has a light reflective film formed thereon, the light reflective film being opposed to the metal electrode, and
wherein the applying light comprises reflecting the light by the light reflective film so that the light enters a region overlapping with the metal electrode.

12. The method of manufacturing a liquid crystal display device according to claim 11,
wherein the light comprises ultraviolet light, and
wherein the light reflective film reflects the ultraviolet light and transmits visible light.
